(19) United States
(12) Patent Application Publication
(10) Pub. No.: US 2008/0028649 A1
(43) Pub. Date: Feb. 7, 2008

(54) Method for designing and constructing a dot-matrix sign display

(75) Inventor: Scott Van Ness, Los Angeles, CA (US)

Correspondence Address: PHILIP H. HAYMOND, 7545 IRVINE CENTER DRIVE, SUITE 200, IRVINE, CA, 92618-2933, US

(73) Assignee: SignResource, Inc. (corp.CA)

(21) Appl. No.: 11/888,278

(22) Filed: Jul. 31, 2007

Related U.S. Application Data
(60) Provisional application No. 60/835,612, filed on Aug. 4, 2006.

(51) Int. Cl. G09F 7/00

(52) U.S. Cl. 40/447

(57) ABSTRACT

An economical method for designing and implementing a computer-controlled illuminated sign from an array or a matrix array of individual light sources.

### CROSS-REFERENCE TO RELATED APPLICATIONS

This patent application hereby incorporates by reference and claims the priority of the filing date of U.S. Provisional Patent Application No. 60/835,612, filed Aug. 4, 2006, Scott Van Ness inventor and entitled: Method For Designing And Constructing A Dot-Matrix Sign Display.

### FIELD OF THE INVENTION

This invention relates to signs and more particularly to a more economical method for designing and constructing a dot-matrix type of sign display including individual or sub panels of discrete light sources.

### BACKGROUND OF THE INVENTION

The following background and description of the prior art and the current invention refers primarily to light-emitting diodes (LEDs) as a light emitting source by way of example, but is meant to also apply to plasma, liquid crystal diode (LCD) and similar future technologies that may be used as individual light sources in segmented or dot-matrix types of arrays used for signage.

LED display arrays for messages and signs are frequently used for commercial or industrial signs. LED display arrays allow for the display of changing characters for viewing at long distances than digital LED displays. LED displays are available as segmented or dot-matrix displays and they allow for numeric and alphanumeric character representation or even the depiction of figures. LEDs are a reliable means of information indication compared to either light sources such as incandescent and neon lamps, they are solid-state devices requiring little power and generating little heat. Because their heat generation is low and because they do not rely on a deteriorating material to generate light, LEDs have long operating lifetimes whereas incandescent bulbs consume much more power, generate a great deal of heat and rely on a filament that deteriorates over time. Neon bulbs, on the other hand, rely on excited plasma, which, along with its electrodes, can deteriorate over time. Although these less efficient light sources may be used together with the present invention, the newer LED technology allows for great economies in the production and functionality of signage.

Dot-matrix type LED displays are generally composed of an array 11, which may be a regularly spaced grid or matrix of light emitting sources 13, LEDs and are commercially available as LED matrix arrays made of sub-panels of matrix type arrays. LED displays can be mounted generally anywhere on a signage panel or case, top or bottom mounted. The individual LEDs of the arrays are selectively activated as individual light sources 13 to act as pixels of a graphic and/or alphanumeric symbol display.

The LEDs of the array are controlled by a programmable computer to activate the LED's in an array to form a particular graphic or alphanumeric symbol. The computer, in combination with the selection of the LED type, can be adapted to display different formats, such as moving text with selectable fonts, as a timer to count down time, as a clock format, etc. or simply as static alphanumeric symbols. Special effects can be added, including a variety of scrolling, wiping, twinkling, flashing, images and animations that function in conjunction with text or as stand-alone effects. The various implementations of computer-controlled programming of individual light sources such as LED matrix arrays will be apparent to those of skill in the art.

In some signage a seven-segment display is employed, shown in FIG. 1A, which generally can satisfactorily display numbers only. The letter ‘Z’ for example would be difficult to display with a seven-segment display. These displays are made of segments 15. Other segmented displays are available, such as the fourteen and sixteen-segment display of FIGS. 1B and 1C which are better able to display numbers and letters because they include more angled segments 15.

FIGS. 2A through 2D show matrix arrays of more discrete light sources 13 rather than the segmented designs of 1A-1C. These matrixes 11 of discreet light sources 13, are used to form a dot-matrix pixel display. In contrast with the segmented displays, a dot-matrix array can be used to display more detailed graphics using the more discreet light sources 13 as pixels and is better suited to display alphanumeric images. An array of LEDs 13 has better resolution and so can be used to display alphanumeric characters in greater detail, allowing these characters to be displayed in different fonts and styles and with a finer resolution proportional to the number of discrete light sources used to make up the array. FIG. 2D shows a comparison between dot matrix and segmented displays.

While a segmented display such as a seven-segment display is ideal for displaying numerals alone they can only be used to display a block type of font which is aesthetically limited and may be unappealing as well. A dot-matrix display affords greater resolution and allows a display employing a variation of the displayed matter so that numerals and words can be displayed is different fonts and sizes. A business may use a particular font in its trademark or trade dress advertising and it would be desirable for them to recreate this font in the changing signage display used by that business.

When a matrix of LED arrays are used to create a dot-matrix sign they may be comprised of a grid of smaller sub-panels, matrixes, shown in FIG. 2B or one large array which may be designed as a matrix, shown in FIG. 2C. FIG. 2A is a typical 5×7 LED panel of the matrix of FIG. 2B, each sub-panel may be used to display a single alphanumeric symbol. FIG. 2B is a view of a single larger grid of 5×7 sub-panels, which are also commercially available. The sub-panel of FIG. 2A shown is as a part of the larger 2×8 matrix grid in FIG. 2B. Individual letters or numbers are formed from selective illumination of the available LEDs. Larger panels, such as the 16×48 panel shown in FIG. 2C are available as well. The higher the density of the LEDs on an array, the higher the display resolution that can be achieved by the sign.

In both segmented and more discrete, round single light source arrays, alphanumeric symbols are displayed by selectively illuminating different individual lights, or pixels, as shown in FIG. 2D. Note that the segmented display is more limited in its ability to display graphics or alphanumeric symbols of different fonts than is the non-segment, more discrete light sources.

Graphic or alphanumeric electronic display panel signs are currently used to display changing data, such as the price of gasoline at a service station. These display drivers can be used to construct a changing graphic message board. These display signs are typically comprised of a number of costly LED graphic panels controlled by drivers, such as those sold by the Maxim Integrated Products company, of Sunnyvale, Calif. for 5×7 matrix LED displays.

Matrix arrays of discrete light sources such as dot-matrix LED displays are ideal for use as a gas price sign because there is no need to manually change static signs to reflect changing prices. Because the display is controlled by a programmable computer the sign prices can be controlled locally or even remotely through the Internet. With the current technology, power requirements are low compared with traditional fluorescent or incandescent lighting used to illuminate painted lettering.

There are some applications where an entire field or matrix of discrete light sources such are LEDs are not needed however. Displaying the price of gasoline for example, requires only that the numerals ‘0’ through ‘9’ be displayed together with a decimal point and optionally a percentage sign. In this sort of application many of the discrete light sources in a field, matrix or array of discrete light sources are never used. Currently a matrix panel of discrete light sources covering the entirety of the display portion of a sign are used and when displaying these symbols with little or no use of some of the discrete light sources. This results in waste and extra expense in building a sign from LED arrays, having to include discrete light sources that are never used.

This same situation arises where only a particular alphanumeric font is intended to be displayed by a matrix of discrete light sources, which would never require the use of some of the discrete light sources available in a standard panel.

What is needed then is a method and a product derived from this method that efficiently makes frugal use of expensive LED or other single-point light emitting panels.

### SUMMARY OF THE INVENTION

A method for economically designing an array of computer-programmable individual light sources used in a sign display is disclosed. The minimum number of individual light sources or matrixes of light sources may be determined for more economically constructing the sign.

A user first determines the overall desired size of a signage display area for a sign. The size, shape and number of one or more individual graphic or alphanumeric characters desired to be displayed on the sign are selected, comprising a character set.

One or more block areas are mapped on the signage display area corresponding to where the individual graphic or alphanumeric characters are to be displayed. For each block area, those graphic or alphanumeric characters desired to be alternately displayed in that block area are overlaid to map a combined character set.

The combined character set for each mapped block is then mapped onto the block, reflecting the only portion of the block that will actually be used to display one of the characters.

For each block, then maps the discrete light sources or matrixes of light sources needed to display the combined character set in the signage display, the blocks corresponding to the combined character set for that block, thereby using the minimal number of light sources or matrixes and more economically constructing a sign by this method.

Different block sizes may be used and if more than one is used in the sign they may be of different sizes. In some cases it may be desired to have one of the block areas display a static graphic or alphanumeric character, such as the ‘ 9/10ths’ character commonly used in the sale of gasoline.

### BRIEF DESCRIPTION OF THE DRAWINGS

FIGS. 1A-1C are diagrams of segmented types of displays.

FIG. 2A is a diagram of a 5×7 matrix array of sub-panels of light sources such as LEDs; FIG. 2B is a diagram of an individual sub-panel matrix array.

FIG. 2C is a diagram of larger matrix array not including sub-panels.

FIG. 2D is a diagram of an array of light sources comparing single character display with single source light sources and segmented light sources.

FIG. 3A is a schematic of a sign showing signage area.

FIG. 3B is a schematic of blocks mapped onto the signage area of FIG. 3A.

FIG. 3C is a schematic of blocks mapped onto the signage area of FIG. 3B after block subtraction.

FIGS. 4A-4C are diagrams of overlaying a character set to create a combined character set.

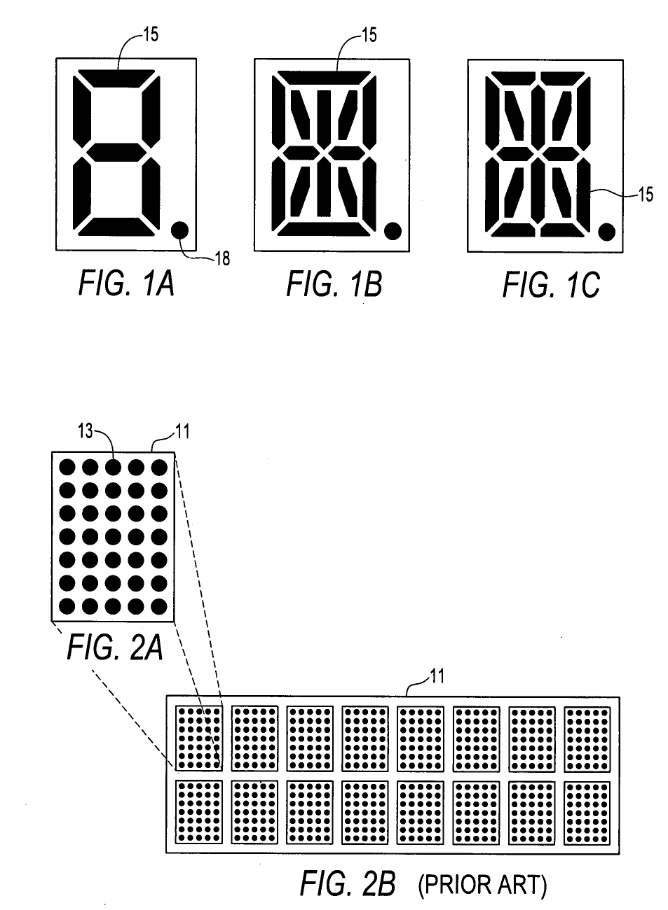

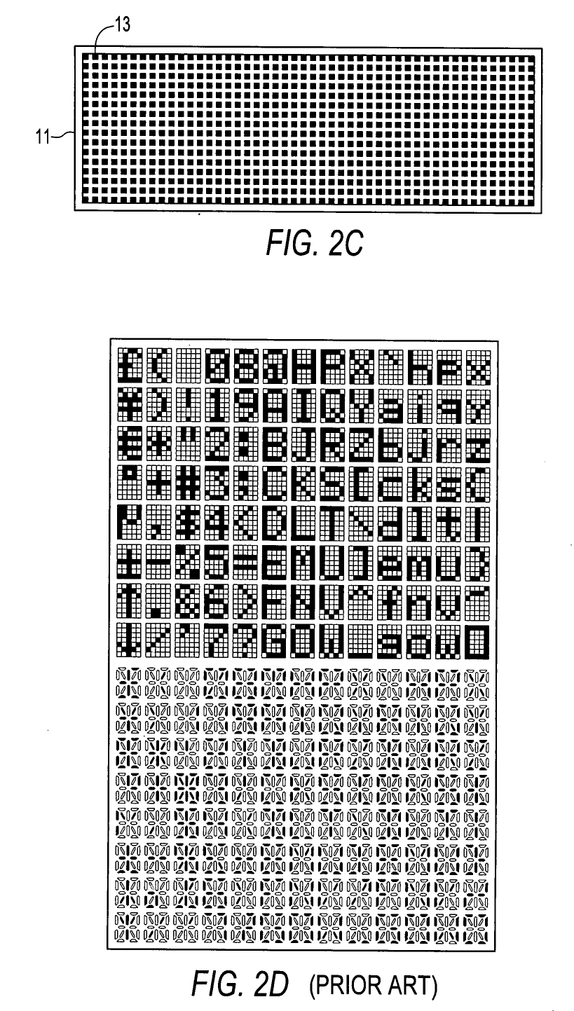

### DETAILED DESCRIPTION OF THE INVENTION

A solution to the above has been devised. The following description, and the figures to which it refers, are provided for the purpose of describing examples and specific embodiments of the invention only and are not intended to exhaustively describe all possible examples and embodiments of the invention.

In the method of the present invention, a desired character set is selected by a user and an array is mapped to include only enough light-emitting sources to display all of the characters of that set. Only enough individual LED segments are placed in an array of discrete light sources, such as LEDs, to achieve the display of that character set. Thus all of the symbols of the character set can be displayed yet with the least use of discrete light sources.

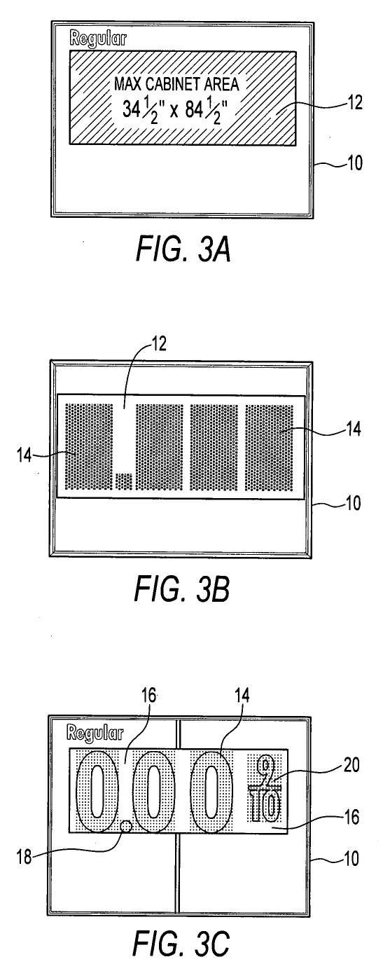

Using a gas station sign by way of example, in one embodiment of the invention, FIG. 3A shows the method of design of an overall sign cabinet area 10, having an area 12 for fitting a lighting display, here shown as 34.5 inches by 84.5 inches by way of example. The signage display area 12 may be other sizes, it may even be the entire size of the sign cabinet area. For a signage display area 12 of about one meter by two meters in size for example, instead of using a single two meter by three meter matrix array 11 (or the equivalent size of many sub-panel displays) block areas 14 of the light emitting sources 15, such as LED's, are determined as in FIG. 3B, to have enough light emitting sources to encompass a sufficient area for a plurality characters.

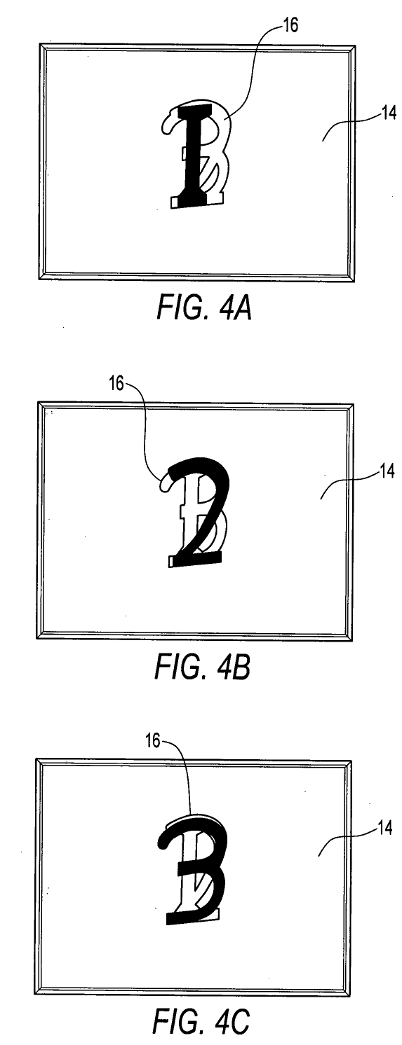

The combined character set for a display is determined and the minimum number of individual light-emitting sources are used to accommodate the combined character set. The combined character set of individual characters are overlaid to account for all of the light sources that will be needed for alternately displaying all of the characters, to determine where blocks 14 should be mapped. For example FIGS. 4A through 4C show at 16 an area determined by the placement of numerals ‘1’ thorough ‘3’ of a particular font over each other, FIG. 4A shows the numeral ‘1’ lit (darkened area); FIG. 4B shows the numeral ‘2’ lit (darkened area) and FIG. 4C shows the numeral ‘3’ lit (darkened area). This method could of course be used with any character set, the character set is successively overlaid to include all needed LED's to produce the entire character set. After the overlaid area is determined, individual LEDs are placed at the needed locations, placed only in those areas that are needed to shown the entire character set.

In an embodiment used with an array comprised of sub-panels of smaller matrix arrays, the sub-panels of light-emitting sources are eliminated in areas of the block areas 16 that will not be used for a given character set, shown in FIG. 3C. The resulting sign uses only the minimal number of sub-panel matrix arrays.

This block subtraction embodiment of the method lends itself to use of sub-panels such as the 5×7 matrix array noted above, for larger panels where a sub-panel is used if any of the light sources on that sub-panel are to be used at all in the display of a character for a given character set.

In constructing the finished sign, after mapping the display area, the minimal blocked areas are mapped for a given character set. Then only enough sub-panels sufficient to display that character set are used to construct the sign, having only sub-panels corresponding to blocks mapped.

In another embodiment, where individual light sources are used instead of sub-panel matrixes, light sources are placed, the block area is mapped, only where needed in areas of the display that are part of the combined character set area on the sign.

This method results in further efficiencies than the above block-subtraction method and is more amenable to being used when the font of a character set is determined in advance and different characters are to be alternately displayed in the same area.

Areas that display only a single symbol may be reduced in area even further to the area needed for that symbol only. For example, for a gas station sign, a decimal place 18 is used and pricing traditionally includes a fractional ‘ 9/10’ 20, shown in FIG. 3C. The designated blocks for these areas are sized to be just sufficiently large enough in area to display this unchanging character.

The methods of the present invention economizes on the number of LED's or LED matrix sub-panels that are needed to produce a given sign, by using only those light-emitting sources that are genuinely required.

It will be appreciated that the invention has been described hereabove with reference to certain examples or preferred embodiments as shown in the drawings. Various additions, deletions, changes and alterations may be made to the above-described embodiments and examples without departing from the intended spirit and scope of this invention.

Accordingly, it is intended that all such additions, deletions, changes and alterations be included within the scope of the claims, below.

What is claimed is:

1. A method for economically designing an array of programmable individual light sources used in a sign display, comprising the steps of:
determining the desired size of a signage display area for a sign,
determining the desired size, shape and number of one or more individual graphic or alphanumeric characters desired to be displayed on the sign, comprising a character set,
mapping one or more block areas on the signage display area corresponding to where the individual graphic or alphanumeric characters are to be displayed,
for each block area, overlaying the characters of the character set desired to be alternately displayed in the block area on the signage display area to map a combined character set,
for each block, placing an array of discrete light sources in the signage display corresponding to the combined character set for that block.

2. The method of claim 1, where the array is comprised of a plurality of sub-panels of matrix arrays and only enough sub-panels are used sufficient to display the combined character set.

3. The method of claim 1 where there are two or more block areas used in a signage display area and at least two block areas are of different sizes.

4. The method of claim 1 where at least one of the block areas used in the signage display area is designed to display only a single character or graphic.

5. A programmable display sign, comprising:
having a signage display area including a plurality of light sources,
where the light sources placed on the sign display area are mapped by first determining the desired size, shape and number of one or more individual graphic or alphanumeric characters desired to be displayed on the sign, comprising a character set,
one or more block areas on the signage display area are mapped, corresponding to where the individual graphic or alphanumeric characters are to be displayed,
for each block area, the characters of the character set desired to be alternately displayed in the block area on the signage display area are mapped to make a combined character set, and
for each block, an array of discrete light sources are affixed to the signage display corresponding to the combined character set for that block.

6. The sign of claim 5, where the array is comprised of a plurality of sub-panels of matrix arrays and only enough sub-panels are used sufficient to display the combined character set.

7. The sign of claim 5 where there are two or more block areas used in a signage display area and at least two block areas are of different sizes.

8. The sign of claim 5 where at least one of the block areas used in the signage display area is designed to display only a single character or graphic.
